(19) United States
(12) Patent Application Publication
(10) Pub. No.: US 2016/0275593 A1
(43) Pub. Date: Sep. 22, 2016

(54) SYSTEM AND METHOD FOR ENABLING A GROUP-BASED MERCHANDISING AND A ONE TOUCH GROUP CHECKOUT

(71) Applicant: Ecole, Inc., New York, NY (US)

(72) Inventors: Jorge A. COSANO-MARTINEZ, New York, NY (US); Osman KHAN, New York, NY (US)

(21) Appl. No.: 15/048,637

(22) Filed: Feb. 19, 2016

Related U.S. Application Data
(60) Provisional application No. 62/118,758, filed on Feb. 20, 2015.

(51) Int. Cl. G06Q 30/06

(52) U.S. Cl. CPC G06Q 30/0631; G06Q 30/0635; G06Q 30/0643

(57) ABSTRACT

A system and method for enabling merchants to present products on an e-commerce web site by category in groups and to enable consumers to purchase a group of items all at once. The system and method also provide for a one-click checkout of an entire group of products which speeds up the checkout out process and makes it more efficient.

### CROSS-REFERENCE TO RELATED APPLICATIONS

This application claims the benefit of U.S. Provisional Application 62/118,758 filed on Feb. 20, 2015, entitled System and Method for Providing a Group-Based Merchandising Model, Predictive Sizing and a One Touch Group Checkout, the contents of which are incorporated herein by reference in its entirety.

### BACKGROUND OF THE INVENTION

This invention relates to a system for implementing ecommerce websites that present purchasing choices in a different manner than existing systems and for enabling a one touch checkout for a group of products.

Today, all fashion and lifestyle ecommerce interfaces are product-centric and follow the same standard process flow and page layout for purchasing merchandise online. They start with a homepage that presents product categories and then links to a grid of products that displays all products available in that category and ultimately drives to product pages where the user can purchase the product. This interface and process is outdated, having been the standard of the ecommerce industry for many years. Such interfaces are also unintuitive and do not provide the user enough context on the products they are purchasing and how they work together e.g. as a look. In addition, since most online stores, from department stores like Barney's to online retailers like Amazon offer a vast selection of products and styles, it is very time consuming for the online shopper to use such websites. For these reasons, online purchasing systems are disjointed and overwhelming for the user.

It is important to note that this process and interface exists not only in fashion and lifestyle online shopping, but also across all other categories in e-commerce that display individual items. For example, customers shopping for a Valentine's Day gift should be able to put together and purchase a group of products that complete the perfect gift with flowers, chocolates, and balloons. Customers shopping for beauty or grooming products should be able to browse across categories to choose and purchase a group of products that create their ideal skincare regimen with a face cleanser, a moisturizer and an eye cream.

Another problem with current ecommerce sites is that a purchaser must repeatedly place items in a shopping cart one at a time or utilize a one-click check out for each individual products purchased. With such systems, users often forget or for some other reason fail to purchase all of the products intended to be purchased, resulting in additional shipping charges to the purchaser or lost revenue to the merchant. There are no known solutions that enable a purchaser viewing a group of products on a screen to purchase the entire group of products with a single click.

It is therefore a principal object of the present invention to provide a system and method for implementing an ecommerce website that presents products in groups of products to potential purchasers.

It is another object of the present invention to provide a system and method for enabling users of an ecommerce website to purchase a group of products through a one touch checkout.

### SUMMARY OF THE INVENTION

The system and method of the present invention enables merchants to present products on an e-commerce website by category in groups and to enable consumers to purchase a group of items all at once. The system and method of the present invention also provide for a one-click checkout of an entire group of products which speeds up the checkout out process and makes it more efficient.

As a result, this invention has applicability to any e-commerce website where grouping items in an array will help the user to browse the product selection and create groups of products that could be purchased together.

These and other features and objects of the present invention will be more fully understood from the following detailed description which should be read in light of the accompanying drawings in which corresponding reference numerals refer to corresponding parts throughout the several views.

### BRIEF DESCRIPTION OF THE DRAWINGS

FIG. 1 is a block diagram of a data communications network for implementing a system and method for providing group-based merchandising according to an embodiment of the present invention.

FIG. 2 is a rendition of one example of a network page generated by a network site implemented in a server in the data communications network of FIG. 1.

FIG. 3 is a flowchart that provides one example of functionality of a service implemented in a server in the data communications network of FIG. 1.

FIG. 4 is a flowchart of the process of prepopulating product groups utilized by the system and method for providing group-based merchandising of the present invention utilized in the data communications network of FIG. 1.

FIG. 5 is a flow chart of the process for checking recommended product groups utilized by the system and method for providing group-based merchandising of the present invention utilized in the data communications network of FIG. 1.

FIG. 6 is a block diagram of the data communications network for implementing a system and method for providing a one touch group checkout according to an embodiment of the present invention.

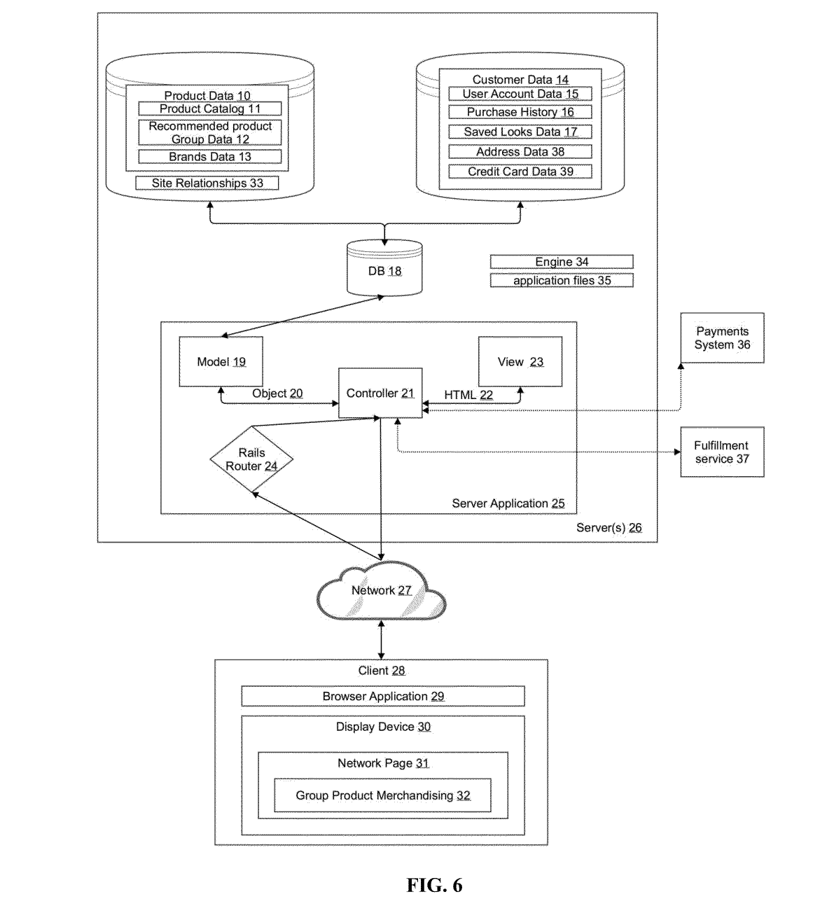

FIG. 7 is a rendition of one example of a network page generated by a network site for implementing a one touch group checkout purchase utilized by the system shown in FIG. 6.

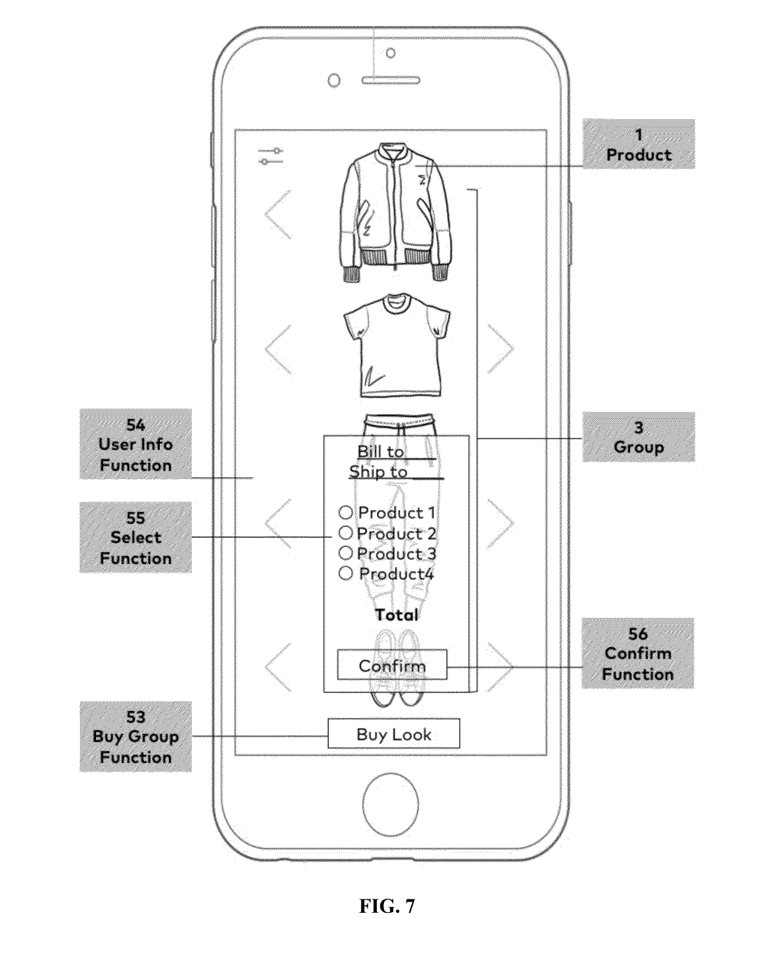

FIG. 8 is a flowchart of the process for implementing a one touch group checkout utilized by the system of the present invention shown in FIG. 6.

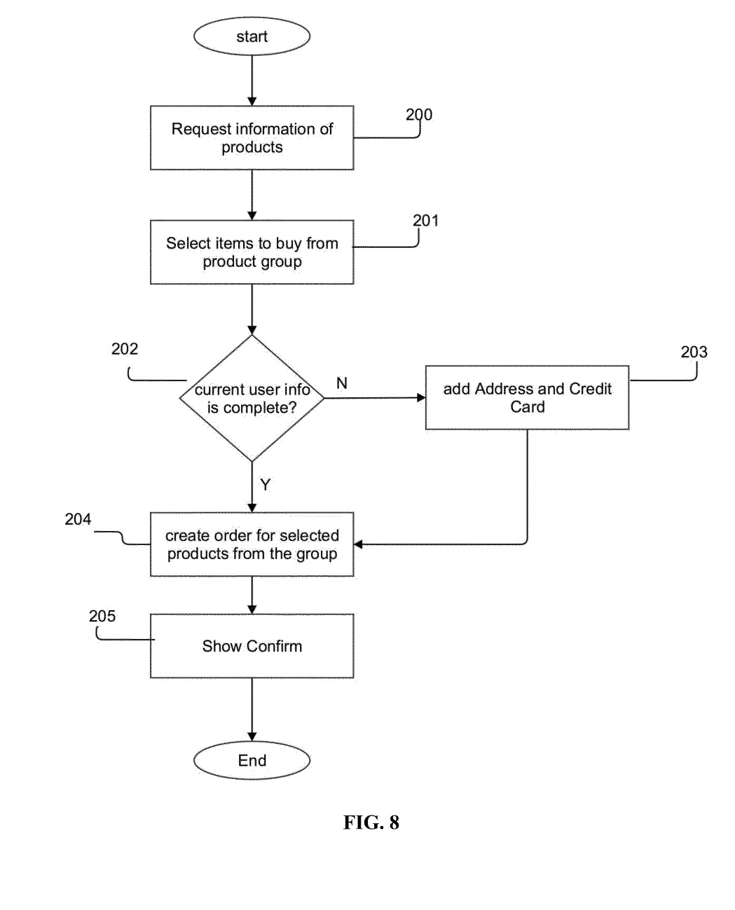

### DETAILED DESCRIPTION

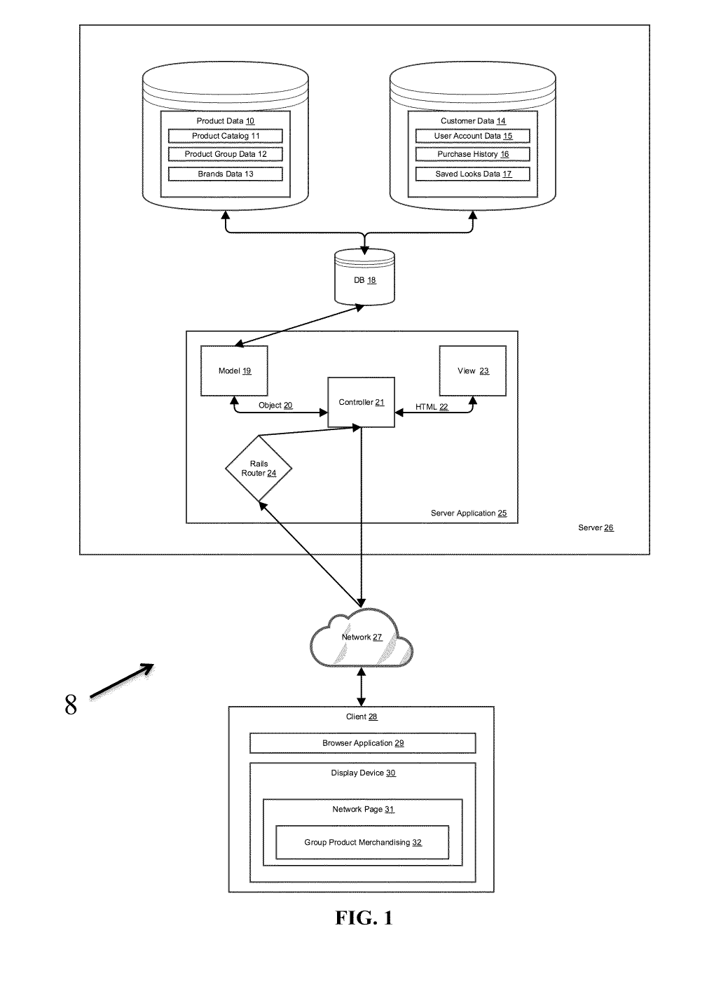

Referring to FIG. 1, the system and method of the present invention for implementing product group merchandising over an online marketplace utilizes a data communications network 10 that includes various computing resources or devices such as server 26 and one or more client devices 28 that are coupled to a network 27. The network 27 may comprise, for example, the Internet, intranets, extranets, wide area networks (WANs), local area networks (LANs), wired networks, wireless networks, or other networks, or any combination of two or more such networks. For purposes of convenience, the one or more servers 26 and the one or more clients 28 are referred to herein in the singular. However, it is understood that in one embodiment, the server 26 may represent a plurality of servers and the client 28 may represent a plurality of clients.

The server 26 comprises one example of a computing resource that may be employed to execute various components as described herein.

Various services, engines, and/or other functionality are executed in the server 26 according to various embodiments. Also, various data is stored in one or more data store(s) represented by data store 18 that is accessible to the server 26. The data stored in the data store 18, for example, may be associated with the operation of the various services, engines, and/or functional entities described below. The components executed on the server 26, for example, include a recommended product group service, and other services, engines, or functionality not discussed in detail herein.

The server application 25 provides for various functions such as maintaining a product catalog, searching for products, effecting payment for products, and other functions. The products sold through server application 25 may comprise, for example, goods and/or services.

To this end, the data store 18 contains, product data 10 that includes but is not limited to, a product catalog 11 in which data about products is stored, product group data 12 and brands data 13. In addition, customer data 14 are stored in the data store 18. Customer data 14 is comprised of user account data 15, purchase history data 16, and saved looks data 17 that are communicated to the data store 18 in the same manner as Product Data 10. The contribution of the Customer Data 14 has a significant impact to the group product merchandising tool 32.

Furthermore, the site relationships 33 include data that indicate a variety of different relationships between a product, category of products, brand, or other data associated with a server application 25. The data relation between objects is created and stored when an administrator adds new instances of different elements of data into the database 18 through the controller 21. The controller 21 uses the model 19 to create an object 20 that includes but is not limited to the relationships between each of the previously described types of data. This collection of data is used to feed and populate the group product merchandising tool 32 with a combination of different products to improve and facilitate the customer experience.

The client 28 is representative of a plurality of client devices that may have access to the network 27. As an example, the client 28 could be one of several millions of clients 28 that are connected to the Internet who want to access the information put forth by the server 26. The client 28 may attempt to access this information through a processor-based system such as a computer system. Such a computer system may include but is not limited to the following list of devices with similar functionalities and capabilities: a desktop computer, a notebook computer, a personal digital assistant, a cellular telephone, a smartphone, tablet computer systems, a digital set-top cable box, digital music players, smart televisions or external digital devices that connect to televisions or any screen providing sufficient access the internet.

In addition, the client 28 may include a variety of different, peripheral devices or digital accessories. In particular, these peripheral devices or digital accessories may include but are not limited to input devices such as a keyboard, keypad, touch pad, touch screen, microphone, scanner, mouse, joystick, or one or more push buttons. The peripheral devices or digital accessories may also include a display device 30, indicator lights or speakers. The display device 30 may include but is not limited to cathode ray tubes (CRTs) screens, liquid crystal display (LCD) screens, gas plasma-based flat panel display screens, LCD projectors, or other types of display devices.

Operating within the client 28 is a variety of applications one of which is a browser application 29. The client browser application 29 is configured to seamlessly and directly interact with the network 27 and also has the possibility to potentially interact with other applications on the server 26 through the server application 25 according to an appropriate and necessary protocol such as the Internet Protocol Suite. This Internet Protocol Suite (IPS) is comprised of the Transmission Control Protocol/Internet Protocol (TCP/IP) or potentially various other protocols. To this end, the browser application 29 may be comprised of, for example, a commercially available browser such as INTERNET EXPLORER® sold by Microsoft Corporation of Redmond, Wash., or MOZILLA FIREFOX® which is promulgated by Mozilla Corporation of Mountain View, Calif., or another type of browser that is readily available and accessible to the general public. Alternatively, the browser application 29 may be comprised of a variety of different yet compatible applications with similar functionalities and capabilities. When the process of the present invention begins and is executed in the client 28 the aforementioned browser application 29 renders network pages 31 readily accessible and operational on the display device 30 by using the message that has been sent to the controller 21 by the involved server application 25 that uses the HTML 22 markup.

The previously referenced browser application 29 interacts and exchanges information with the network 27 in order to obtain access to specific and varied information from the server 26 to execute the appropriate process. The rails router 24 receives a message that has been passed by the network 27 using the Hypertext Transfer Protocol (HTTP) Methods for RESTful Services such as POST, GET, PUT, PATCH, DELETE. The rails router 24 processes the received message and uses this message to identify the related controller 21 that is responsible for processing the requested information. The controller 21 processes the requested information by getting the necessary and pertinent objects 20 that have been extracted from the data store 18 using the model 19 and returns a response to the requesting service that depends on the type of message that has previously been sent.

A model 19 uses Structured Query Language (SQL) to submit a query to the data store 18 and extract information into instance objects of the specific model 19. For example, if the model 19 is getting information about a user, it will query the data store 18 with SQL and store the user information into an object User that can be used by the controller 21 and the view 23. Each object 20 created by a model 19 has a different state, and no two objects 20 are the same. If the controller 21 changes the state of the object by changing any of the user information due to a request from the browser application 29, the object will be accessed again by the model 19 to store the changed information (new state) to the data store 18.

If the message format is JavaScript Object Notation (JSON), the response will be return as a JSON object that contains all related information extracted or changed by the model 19. If the message is a HTML render message, the controller 21 sends the related objects to the view 23 to create a HTML markup using the objects information to return to the browser application 29 through the network 27. The browser application 29 renders the network page 31 using the HTML 22 markup returned by the controller 21.

### Product Group Based Merchandising Tool:

The product group based merchandising tool 32 has been created and configured to provide an intuitive merchandising and shopping experience by displaying a combination of items from different product categories. By displaying this combination of items to the client 28, the group product merchandising tool 32 facilitates the viewing, alternation, selection and potential simultaneous purchase of a combination of products from different product categories. The detailed functionality of the group product merchandising tool 32 will be further described below.

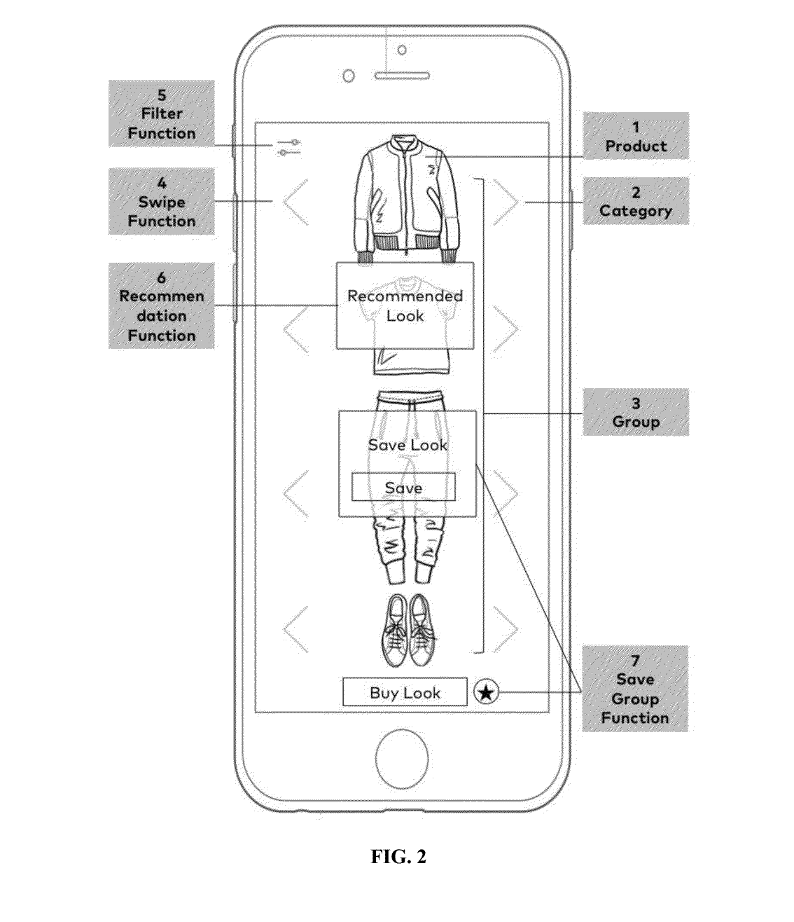

A system administrator defines the different elements stored in the product data 10 within the data store 18. A system administrator is a user with administration privileges. The system administrator may be, but is not limited to: an employee of a store, a professional stylist, a designer etc. who has experience grouping related products together. The information defined by the system administrator (and which may be displayed on a mobile device as shown in FIG. 2) may be, but is not limited to: the products 1 contained in the product catalog 11, the type of product categories 2, and the recommended product groups 3.

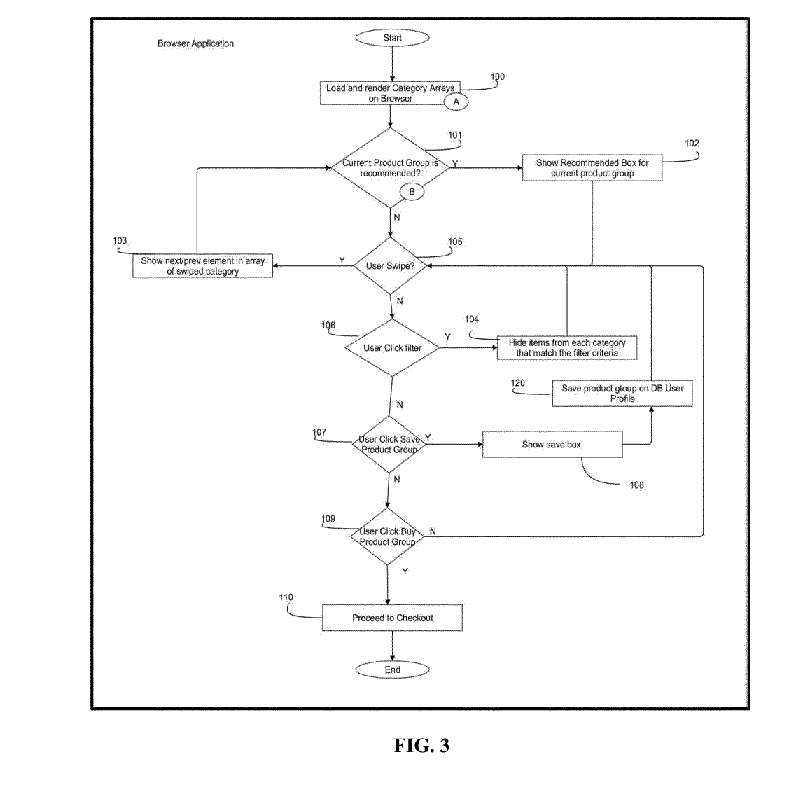

Referring now to FIG. 3, the process for implementing the group merchandising will now be explained. In step 100, the browser application 29 sends to the network 27 a request to render a network page 31 in which the group based merchandising tool 32 is displayed. The rails router 24 identifies the GET HTTP message and passes the parameters of the message URL to the controller 21 with such a request.

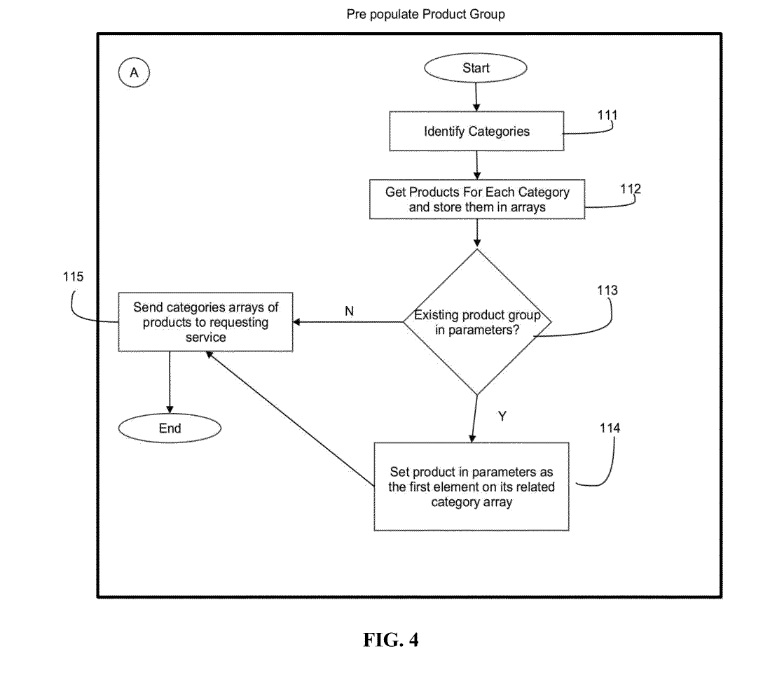

The process in which the controller 21 processes the information is shown in FIG. 4. In step 111, the controller 21 first identifies the different categories to be displayed within the network page in the group based merchandising tool 32 by searching the message parameters for the related categories. The parameters are elements inside the JSON object message stored as key value pair inside a hash (A hash function is any function that can be used to map data of arbitrary size to data of fixed size.), for example a parameter may have key categories and store in its value an array of the categories (eg: categories=>[outerwear, shirts, pants, shoes]). Next, in step 112, the controller 21 uses the model 19 to retrieve product objects from the data store 18 and store them in class variable arrays (one for each category). In step 113, the controller 21 checks the parameters of the original message sent from the browser application 29 through the network 27 for a product group by going through each product stored in the parameters as key value pairs from each category. The products in the message are extracted from the network page by the browser application 29 through the original request URL in which the categories found where previously defined by the administrator. The controller 21 checks for a product group and returns a true or false value along with the product group wrapped on a hash. If a product group is found, in step 114, each element (product) of the product group is searched inside each of the instance arrays of categories recently defined and is placed on the first index of the current array. This process will ensure that the first element of each of the instance array categories will be the related to the product group found on the parameters as described above. Finally, in step 115, the controller 21 sends the category instance class arrays to the view.

The controller 21 message passed to the view 23 requests an HTML markup that the browser application 29 needs to render the network page on the client display device 30. The message sent by the controller 21 includes the instance variable arrays previously sent. The view 23 uses the parameters on the message to extract the correct template from the server application files 35 and uses the different variables passed as arrays along with the current user object accessed through the controller 21—model 29 interaction to return a HTML markup response that the controller 21 sends back to the network to be then directed to the browser application 29 for use to render the requested network page.

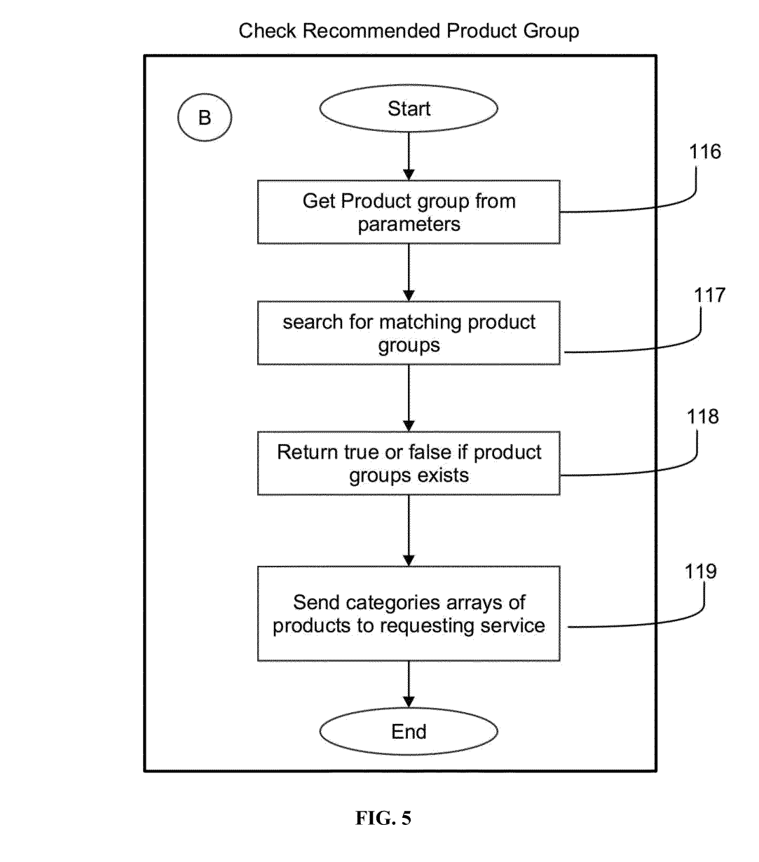

After the network page is rendered with the elements returned from the controller 21 as described above, in step 101 the browser application activates a process to check if the current product group 3 that is displayed on the network page 31 is a recommended set of products. If so, the network sends an asynchronous message through the network to the server application 25 as JSON with the current displaying group product as parameters. This process is shown in FIG. 5.

In step 116, the controller 21 receives the JSON Request after being processed and assigned by the rails router 24 and stores the product names from the groups on different variables. After getting the information from the parameters of the request message, in step 117 the controller 21 sends the set of variables to the group product model 19 as an array to search on the data store 18 for product group relations that contain the same type of arrangement of products contained inside the requested array. The model 19 queries the data store 18 for matching patterns using SQL commands and wraps the response of the query in an object that contains the matched product group in its state. The model 19 then responds back to the controller 21 with the recently extracted object. If no relation was found in the data store 18, the model 19 returns a not found message. In step 118, the controller 21 receives a message or the object back from the model 19 and creates a JSON message with the object or the not found message. Finally, in step 119, the controller 21 sends a JSON Object message and sends it as a response to the browser application 29 through the network 27.

The browser application 29 receives the response JSON object sent thought the network and reads the JSON object to check for a success or failure message. If the message returned is success (a group product object was found in the data store 18 as recommended.), in step 102, the browser application 29 displays an element in the network page 31 as “Recommended” 6 and may use some elements of the JSON response to display important information to the user such as name of the look, total price, a description etc. All relevant information is accessed from the group product object that was wrapped inside the JSON response from the controller 21.

The browser application 29 tracks special events and attaches event handlers to the elements on the network page 31 to activate processes/functions depending on user behavior. In step 105, if the browser application 29 reads a swipe 4 event by the user, the event triggers the process in step 103 to identify the direction of the swipe event and its category 2 to show the next/previous element (product image 1) on the array and hide the current element only for the category 2 that received the interaction.

Each of step 105/103 events trigger the check if a current group is recommended as described above with reference to step 101.

In step 106 the filtering event, filters over the categories displayed on group product merchandising tool 32 category sections loaded on the network page 31. If a filter function 5 is triggered due to an interaction with the filter icon, the event 106 causes the browser application 29 to display the filtering options on the network page 31 to allow the current user to check or uncheck the category of items to hide from each category of products.

The filter menu contains but is not limited to: city filter, brands filters, price filters, saved filters, past purchased filters, etc. A User can interact with any of the check box elements related to a specific filter by clicking on the check box input to activate or deactivate the filter. On the event of active or inactive clicking of a check box, the web browser application 29 processes the information related to the event-triggered element to extract the information of the type of filter. After getting the filter information, the browser application 29 handles the event by starting the process in step 104 where a function will look into the current category arrays displayed on the group product merchandising tool 32 shown on the network site to hide or show the elements that match the arguments passed by the browser application 29 (category previously extracted on the event-triggered).

After the filters are applied, the user can continue swiping and filtering each event will again trigger the events described before.

Another important User event is the save group function 7. The Save Look function 7 is triggered on the event that the user clicks on the save icon displayed on the network page 31. The browser application 29 identifies the event triggered by the click event and displays a previously hidden box element in the network page 31 that includes but may not be limited to a text field describing the save look process and an input step expecting a name to be assigned to the current displayed product group. When an input is received and the submit button is clicked, the web browser 29 handles the event and wraps the information of the current product group along with the input fields of the save step into a JSON object that then sends to the server application 25 through the network 27.

The message goes through the Rails Router 24 that reads the HTTP request and identifies the controller 21 that will handle the call. In step 120, the controller receives the message and passes the values in the parameters related to the product group and the assigned value of name to the model 19 for storage. The model 19 receives the values of the parameters as arguments and creates a new object with a new state that holds the information of the group and name. Upon creation of the object, the model 19 stores the group data into the saved group data 17 and its relations to the customer data 14 in the data store 18. When the process is finished, the model 19 returns the object recently created back to the controller 21. The controller 21 handles the message as JSON and returns back a JSON object of success or failure (error on saving group) along with the object 20 if returned by the model 19.

The network 27 directs the returned message back to the client 28 browser application 29. The browser application 29 receives the message and processes it as failure or success to show the user a message extracted from the JSON object response.

In step 109, the web browser 29 looks for a click event that triggers the checkout flow process (described below) and referenced in step 110.

### Checkout Flow:

When the Buy Group function 53 event is triggered, in step 200, the browser application 29 handles the event and sends a request message through the network 27 using HTTP to get information about the product group displayed the moment the event was triggered. After the rails router 24 receives the request, it directs the message to the appropriate controller 21 to handle the process. The controller 21 receives the message and retrieves the product group stored within its parameters. With this information, the controller 21 uses the model 19 to search for each of the received items. The model 19 submits a data query to the data store 18 and returns a new object for each product with all corresponding information stored in its current state. The controller 21 takes the data from the objects returned by the model 19 and sends a JSON response back to the browser application 29 through the network 27. The browser application 29 then processes the JSON response message previously received and displays a box element in the network page 31. This box element details all the products from the current product group and its available sizes within a check input field menu. This enables the user to interact and select the final products selection that will be processed.

When the product selection box is displayed, in step 201, the user has the option to check the final product and sizes that will be purchased.

If the User finalizes the selection of final products and sizes to be purchased, the Confirm function 56 event triggered by the user interaction creates a process on the browser application 29. The purpose of this process is to validate if the current user account data 15 is complete to proceed with the checkout or if additional information is required. In step 202, the browser application 29 sends a request through the network 27 to the controller 21 to obtain information about the current user by using a standard HTTP GET method. After the rails router 24 directs the message to the correct controller handler, the controller 21 communicates with the user model 19 to get all the information from the current user. The model 19 gets the parameters passed on the current session user id to extract the information about the specific user stored within the user account data 15. The model 19 returns a user object with all information and relations including but not limited to address information and credit card information. The controller 21 then wraps the user object into a JSON object to then send a response back to the browser application 29 through the network 27. The browser application 29 receives the JSON element and reads the response object to search for a previously stored default credit card and address. In step 203, if any of the elements are not present, the browser application 29 displays a box element with a form field on the network page that asks the user for the relevant missing information (address or credit card information). After the user inputs the missing information into the form and triggers the Confirm function 56 event for the current group order in step 204, the browser application 29 sends through the network 27, a request with the new data information along with the final product selection and sizes picked by the user during the previous steps wrapped in a JSON object.

The controller 21 receives the JSON object after the rails router 24 has directed the message and extracted the information stored in it. With this information, the controller 21 uses the model 19 to create the new object(s) credit card and/or address found in the parameters of the JSON message and stores the new information to the data store 18 with the appropriate relationship to the current user. In the case of the credit card, the model 19 stores only the last 4 digits of the credit card and communicates via an API (application program interface) through the network 27 to a payment system service 36 outside the scope of the server application 26. The payment system service 36 stores the credit card data information and returns a unique key associated to the credit card for future use. The model 19 stores this key on the recently created credit card object and updates the data on the user account data 15.

The controller 21 uses the model 19 to create a new order object with the product information extracted from the JSON object. The new order object is then processed with the payments and credit cards stored on the user account data 15 all the order information is stored by the model 19 on site relations 33 and linked to the user account data 15. When the order is completed, the controller 21 returns a message to the browser server with the new order information through the network 27. At the same time, the controller 21 sends a message with the current order via API to a fulfillment service 37 outside the scope of the server application 26.

The browser application 29 receives the JSON response from the controller 21 via the network 27 and reads the JSON object to extract information about the order including but not limited to order confirmation number, order created date, order payment details etc. Finally in step 205, the browser application 29 displays a box element on the network 27 including information about the order that was processed.

The various applications or other components described above may be implemented using any one or more of a number of programming languages such as, for example, C, C++, C#, Visual Basic, VBScript, Java, JavaScript, Perl, Ruby, Python, Flash, or other programming languages.

The foregoing invention has been described with reference to its preferred embodiments. Various alterations and modifications will become apparent to those skilled in the art, and all such alterations and modifications are intended to fall within the scope of the appended claims.

What is claimed is:

1. A system for enabling a merchant to present products as a group of products comprising;
a data store for storing product data and customer data;
a computer server capable of communicating with client devices over a communications network to enable users of client devices to view and purchase groups of products in different product categories on client devices, said computer server includes:
a model for retrieving product objects from said data store and storing said product objects in class variable arrays with one of said arrays being assigned to each category;
a controller for reviewing incoming request for a display of products to determine if such products are included in said class variable arrays, said products are placed on a first index of an array in which the product was found; and
a view for creating one or more pages of information on product groups taken from said class variable arrays and providing said pages to said controller for communication over said communications network to a client device.

2. The system for enabling a merchant to present products as a group of products of claim 1 wherein the model searches said data store for product objects in categories related to products identified in said requests for products.

3. A system for enabling a one click check out process for a group of products selected for purchase by a buyer comprising:
a data store for storing product data and customer data;
a computer server capable of communicating with client devices over a communications network to receive purchase requests from a buyer for a group of products, said computer server including:
a model for retrieving information relating to the buyer and on products selected for purchase by the buyer;
a controller for transmitting a confirmation request to a communications network for transmission to the buyer and for receiving from said communications network a purchase confirmation made by the buyer, said controller using information in said confirmation and information received from said model for completing the purchase, said controller also transmitting a notice to a fulfillment service to request the delivery of said products; and
a view for creating one or more pages of information relating to the processing of said purchase for communication over said communications network to a client device.

4. A method for enabling a merchant to present products as a group of products comprising the steps of:
storing product data and customer data in a data store;
retrieving product objects from said data store and storing said product objects in class variable arrays with one of said arrays being assigned to each category of products;
receiving incoming requests over a communications network for a display of products on a client device;
reviewing one or more incoming requests for a display of products to determine if such products are included in said class variable arrays,
if a product is found in said class variable arrays, placing said product on a first index of an array in which the product was found
transmitting one or more pages of information on product groups taken from said class variable arrays to a communications network for display on a client device

5. A method for enabling a one click check out process for a group of products selected for purchase by a buyer comprising the steps of:
receiving purchase requests from a buyer for a group of products;
retrieving from a data store, information on the buyer and on products selected for purchase by the buyer;
transmitting a confirmation request for confirmation of a purchase of a group of products by the buyer to a communications network for transmission to the buyer;
receiving from said communications network a purchase confirmation made by the buyer;
using information in said confirmation and information relating to the buyer received from said data store to complete the purchase;
transmitting a notice to a fulfillment service to request the delivery of said products;
transmitting one or more pages of information relating to the processing of said purchase.

6. The method for enabling a one click check out process for a group of products of claim 5 further comprising the steps of:
transmitting buyer information retrieved from said data store to a communications network for delivery to the buyer for confirmation of said buyer information by the buyer;
if said buyer information is updated by the buyer, updating said buyer information stored in said data store.
